(19) United States
(12) Patent Application Publication
(10) Pub. No.: US 2008/0136172 A1
(43) Pub. Date: Jun. 12, 2008

(54) TAPERED ANNULAR GASKET AND JOINT FOR USE OF SAME

(76) Inventors: Thomas O. Roe, Stoughton, WI (US); David Toy, Madison, WI (US)

Correspondence Address: Kunzler & McKenzie, 8 EAST BROADWAY, SUITE 600, SALT LAKE CITY, UT, 84111, US

(21) Appl. No.: 11/609,225

(22) Filed: Dec. 11, 2006

(51) Int. Cl. F16L 17/08

(52) U.S. Cl. 285/113

(57) ABSTRACT

An apparatus is disclosed that includes a gasket having an annular shape and characterized by an outer circumference and an inner circumference. The gasket is further characterized by an inner thickness, proximate the inner circumference, tapering to an outer thickness, proximate the outer circumference. The inner thickness of the gasket is substantially greater than the outer thickness. The gasket includes a first contact surface extending between the inner and outer circumferences, and a second contact surface, opposite the first contact surface, extending between the inner and outer circumferences.

### BACKGROUND OF THE INVENTION

1. Field of the Invention

This invention relates to gaskets and more particularly to tapered annular gaskets and joints for use of same.

2. Description of the Related Art

Emission standards, which set specific limits with respect to the amount of pollutants that may be released into the environment, are becoming more and more stringent. For example, current EPA guidelines continue to reduce allowable diesel exhaust emissions, with current acceptable emissions approaching zero. Although this may be positive for the environment, these regulations create a significant challenge to engine manufacturers.

For manufacturers of diesel engines, complying with current emissions standards may require use and development of a combination of techniques, including but not limited to exhaust gas recirculation (EGR), crank-case ventilation, and exhaust after-treatments systems. After-treatment systems, in particular, may include various components for treating exhaust. These components may include, for example, diesel oxidation catalysts (DOC), diesel particulate filters, selective catalytic reduction systems, or the like.

In certain situations, after-treatment systems may be provided in the form of a canister, resembling a muffler, used to replace or supplement a conventional muffler. This canister may be provided in cylindrical sections to facilitate servicing and replacement of the internal components of the after-treatment system or to remove or replace the sections themselves. These sections typically require serviceable joints to prevent leakage of exhaust gases between the sections.

In many after-treatment systems, the cylindrical sections of the canister are flared outward by ninety degrees to accommodate flat gaskets or flat formed beaded joints. Other joints use round gaskets contacting flat or machined surfaces of the flared sections. The gaskets used to seal these joints are typically constructed of graphite materials that are resistant to high temperatures and capable of preventing gas leakage. These gaskets are usually soft and compressible to provide an effective seal. However, the soft compliant characteristics of the gasket also make them more vulnerable to distortion and crushing where there is not proper support. Furthermore, although functional, the joints of current after-treatment systems make it difficult and time-consuming to clamp the sections of the after-treatment system together.

In view of the foregoing, what is needed is an improved joint that provides additional clamping force between the sections and an improved ability to retain the clamping force generated. Further needed are novel gaskets to provide a seal in such a joint. Ideally, such a joint would provide improved durability, significantly lower costs, and easier installation and service.

### SUMMARY OF THE INVENTION

The present invention has been developed in response to the present state of the art, and in particular, in response to the problems and needs in the art that have not yet been fully solved by currently available apparatus. Accordingly, an improved joint has been developed for use with an after-treatment system or other similar or related device. Further disclosed is a novel gasket to provide a seal in such a joint.

In one aspect of the invention, an apparatus in accordance with the invention includes a gasket having an annular shape and characterized by an outer circumference and an inner circumference. The gasket is further characterized by an inner thickness, proximate the inner circumference, tapering to an outer thickness, proximate the outer circumference. The inner thickness of the gasket is substantially greater than the outer thickness. The gasket includes a first contact surface extending between the inner and outer circumference, and a second contact surface, opposite the first contact surface, extending between the inner and outer circumference.

In certain embodiments, the apparatus includes first and second cylindrical sections having flares along their respective circumferences. The flares form obtuse angles relative to the cylindrical sections. A V-band clamp may be provided to contact and urge the first and second flares toward one another, thereby compressing the gasket and creating a seal between the flares.

In certain embodiments, the apparatus may include a support member to provide radial support to the gasket and to keep the gasket positioned between the first and second flares. The support member may be a separate component from the gasket or, alternatively, the support member and the gasket may be integrated or attached together.

In another aspect of the invention, an apparatus in accordance with the invention includes an annular gasket characterized by an outer circumference and an inner circumference. The annular gasket has a cross-section the thickness of which tapers from the inner circumference to the outer circumference. The gasket further includes a first contact surface extending between the inner and outer circumference, and a second contact surface, opposite the first contact surface, extending between the inner and outer circumference.

In yet another aspect of the invention, an assembly, or “joint,” in accordance with the invention includes an annular gasket characterized by an outer circumference and an inner circumference. The annular gasket has a cross-section the thickness of which tapers from the inner circumference to the outer circumference. The annular gasket has a first contact surface extending between the inner and outer circumference, and a second contact surface, opposite the first contact surface, extending between the inner and outer circumference. The assembly further includes first and second cylindrical sections having flares along their respective circumferences. The flares form obtuse angles relative to the cylindrical sections. A support member provides radial support to the annular gasket to keep the annular gasket positioned between the flares. A V-band clamp contacts and urges the flares toward one another.

The present invention relates to an improved joint and gasket for use with an after-treatment system or other similar or related device. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a perspective view of one embodiment of an after-treatment system showing an exemplary application for a gasket and joint in accordance with the invention;

FIG. 2 is a perspective cutaway view of a joint showing one embodiment of a gasket in accordance with the invention;

FIG. 3 is a perspective cutaway view of one embodiment of a gasket in accordance with the invention;

FIG. 4 is an exploded perspective view of a joint showing one embodiment of a gasket and support member in accordance with the invention; and

FIG. 5 is a perspective view of one embodiment of a V-band clamp used with a joint in accordance with the invention.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of apparatus in accordance with the present invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

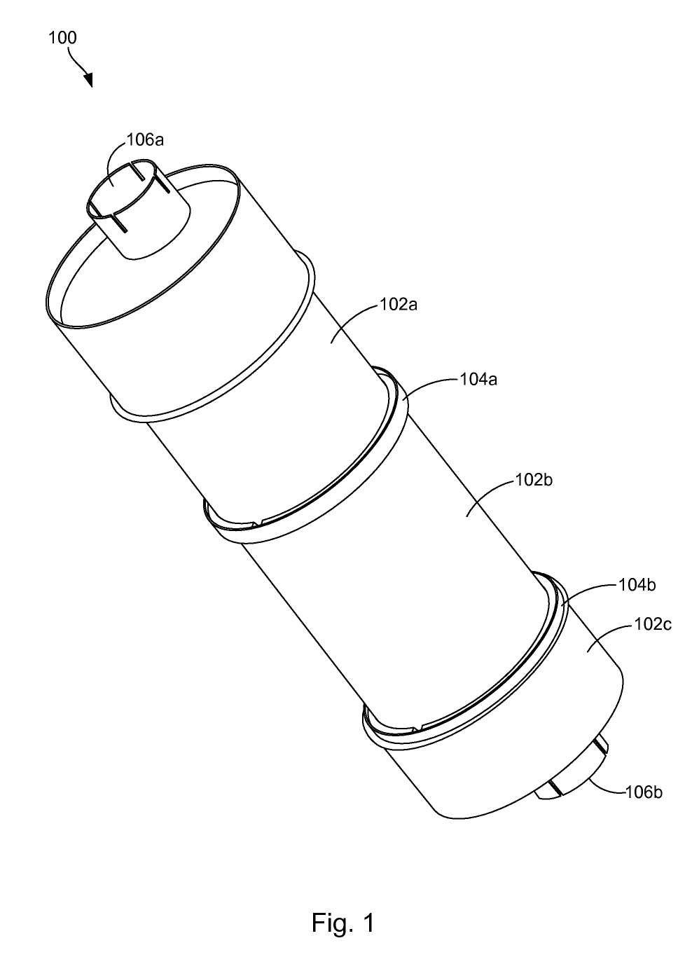

FIG. 1 illustrates one embodiment of an after-treatment system 100 for use with a joint and gasket in accordance with the invention. Although particular reference is made herein to an after-treatment system 100, the joint and gasket described herein may be used in various different systems or devices. Thus, the joint and gasket is not limited to use with after-treatment systems 100. For example, a joint and gasket in accordance with the invention may be used with mufflers, catalytic converters, exhaust pipes, or other devices requiring a coupling and seal between two cylindrical tubular sections. Thus, the illustrated after-treatment system 100 is simply one exemplary application among many for the joint and gasket disclosed herein.

In certain embodiments, an exhaust after-treatment system 100 may resemble a cylindrical canister and may be used to replace or supplement a conventional muffler. Such a system 100 may include an inlet 106a, an outlet 106b, and two or more cylindrical sections 102a-c. Dividing the system 100 into cylindrical sections 102a-c may enable service and replacement of various internal components of the after-treatment system 100, as well as individual removal or replacement of the sections 102a-c themselves. In selected embodiments, the cylindrical sections 102a-c may be used to house one or more exhaust treatment devices such as but not limited to diesel oxidation catalysts (DOC), diesel particulate filters, selective catalytic reduction systems, and the like. To prevent the escape of untreated emissions or other gases from the system 100, the cylindrical sections 102a-c may include serviceable joints 104a, 104b. These joints 104a, 104b create a seal between the sections 102a-c while enabling the after-treatment system 100 to be dismantled for repair, replacement, and servicing.

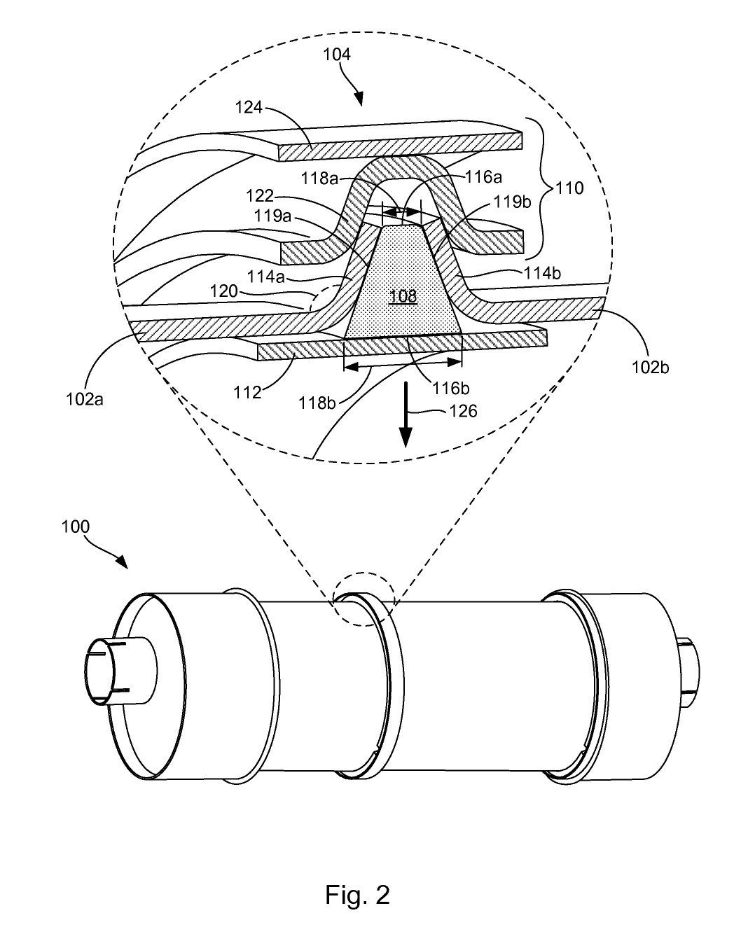

Referring to FIG. 2, in selected embodiments, a joint 104 in accordance with the invention may include a gasket 108, a V-clamp 110, and a support member 112. The gasket 108 may be inserted between flares 114a, 114b of the cylindrical sections 102a, 102b to provide a seal there between. The gasket 108 may be in an annular, or “donut,” shape and be characterized by an outer circumference 116a and an inner circumference 116b. The gasket 108 may further have an inner thickness 118b, proximate the inner circumference 116b, tapering to an outer thickness 118a, proximate the outer circumference 116a. The inner thickness 118b may be substantially greater than the outer thickness 118a to give the gasket 108a tapered profile.

The gasket 108 may include a first contact surface 119a extending between the inner circumference 116b and outer circumference 116a. A second contact surface 119b, opposite the first contact surface 119a, may extend between the inner circumference 116b and outer circumference 116a. The gasket 108 may be constructed of various soft or compressible materials, such as graphite-based materials, that are resistant to high temperatures while providing an effective seal to prevent the leakage of emissions.

The flares 114a, 114b may form an obtuse (i.e., greater than ninety degree) angle 120 relative to the cylindrical sections 102a, 102b in order to conform to the tapered profile of the gasket 108. An angle 120 of about 110 degrees may be suitable, although the angle may be varied to measure within a range of about 95 to 170 degrees. A V-clamp 110, which may include a V-band 122 and a tension strap 124, may be used to urge the flares 114a, 114b together to compress the gasket 108. That is, the V-band 122 may urge the flares 114a, 114b together as it is pressed over the flares 114a, 114b in the direction 126 by the tension strap 124.

Due to the angle 120 of the flares 114a, 114ba and the tapered profile of the gasket 108, the gasket 108 may tend to migrate in the direction 126 upon tightening the V-clamp 110. This is due to the radial force exerted on the gasket 108 in the direction 126. To counteract this force and keep the gasket 108 positioned between the flares 114a, 114b, a support member 112 may be used to provide radial support to the gasket 108. The support member 112 may be a cylindrical structure made of a suitable metal, alloy, composite, or other material to provide the desired amount of radial support. In selected embodiments, the support member 112 may be constructed of a same a similar material used for the cylindrical sections 102a, 102b.

In certain embodiments, the support member 112 may be attached to the gasket 108 prior to installing the gasket 108 in the joint 104. In other embodiments, the support member 112 may be installed separately from the gasket 108. In yet other embodiments, the support member 112 may be welded or adhered to one of the cylindrical sections 102, 102b. The gasket 108 may then be slid over the support member 112 to provide the desired radial support.

The tapered profile of the gasket 108 and flares 114a, 114b may provide various engineering advantages and cost savings compared to joints utilizing a ninety-degree flare and flat gasket approach. For example, the tapered profile of the flares 114a, 114b enables the V-clamp 110 to exert a greater clamping force on the flares 114a, 114b and to better retain the clamping force generated. This, in turn, provides a seal that is robust and reliable in preventing exhaust leaks. The angled flares 114a, 114b may also be easier and cheaper to form on the cylindrical sections 102a, 102b that ninety-degree or other more complicated flares. The joint 104 is also easy to install and service and provides better interaction between the V-clamp 110 and flares 114a, 114b. The resulting joint 104 thus provides a solution that is robust while cost-effective.

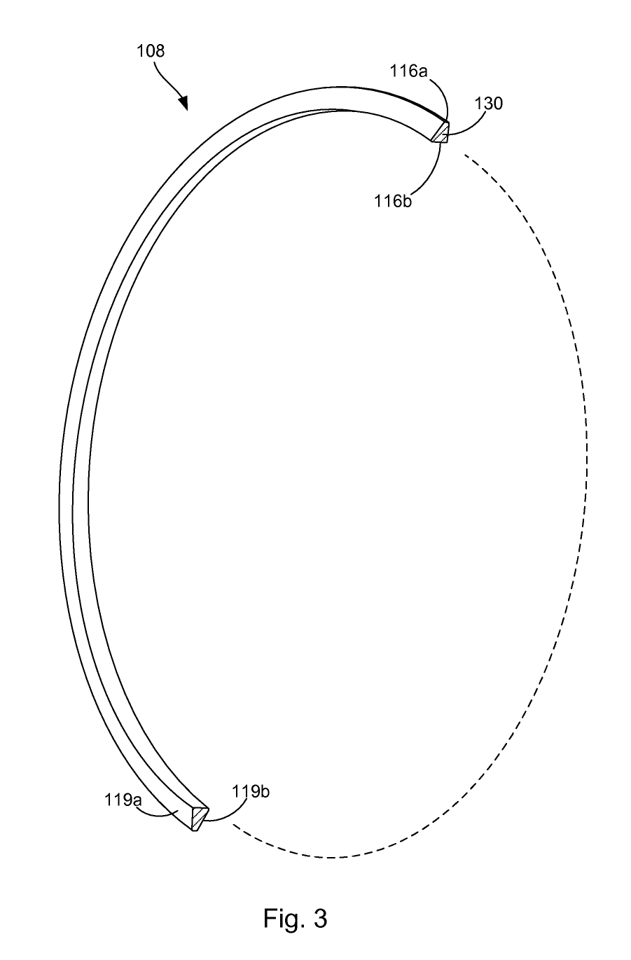

FIG. 3 is a perspective cutaway view of the gasket 108 illustrated in FIG. 2. As illustrated, the gasket 108 is characterized by an annular, or “donut,” shape. A cross-sectional area 130 of the gasket 108 may have a substantially triangular or trapezoidal shape 130 to give the gasket 108 its tapered profile. Other tapered cross-sectional shapes 130 are also possible. The gasket 108 includes a first contact surface 119a extending between the inner and outer circumferences 116a, 116b. A second contact surface 119b, opposite the first contact surface 119a, also extends between the inner and outer circumferences 116a, 116b. These contact surfaces 19a, 119b are pressed against the flares 114a, 114b of the cylindrical sections 102a, 102b to seal the joint 104.

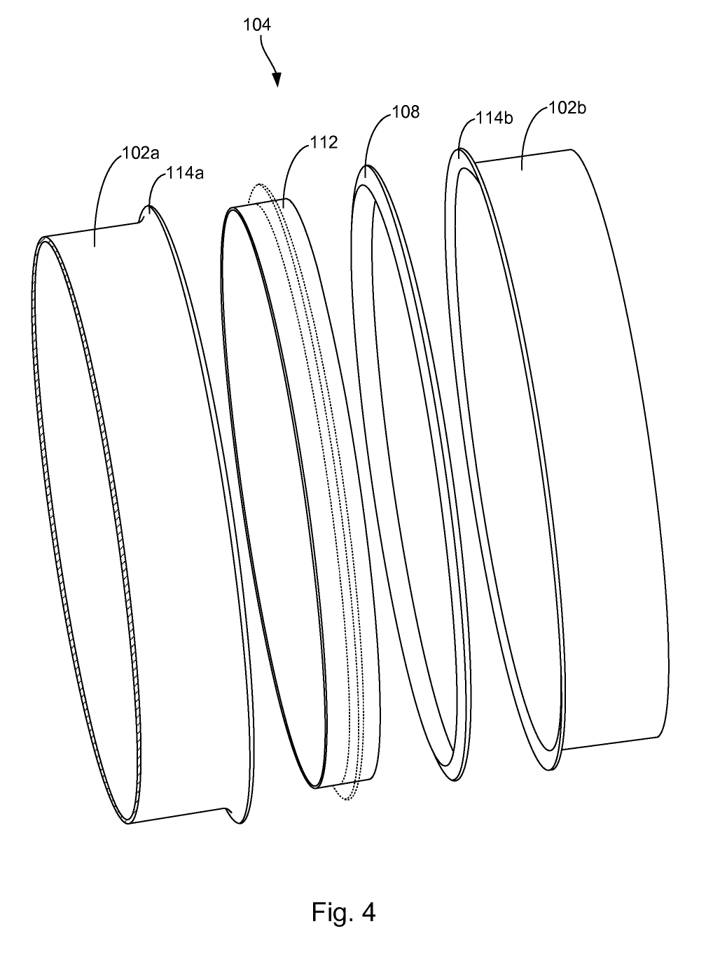

FIG. 4 is an exploded perspective view of the joint 104 showing one embodiment of a gasket 108, support member 112, and cylindrical sections 102a, 102b. The V-clamp 110 is not shown to avoid obstructing the view of other components. As shown, the cylindrical sections 102a, 102b include flares 114a, 114b that interface with and contact the gasket 108. A support member 112 is used to provide radial support to the gasket 108 to maintain its position between the flares 114a, 114b.

In certain embodiments, the gasket 108 may be inserted over the support member 112 prior to assembling the joint 104. This may allow the gasket 108 and the support member 112 to be installed in the joint 104 simultaneously as a single assembly. Optionally, the gasket 108 may be attached, by adhesives or other means, to the support member 112 prior to installation.

In other embodiments, the support member 112 and gasket 108 may be installed separately and consecutively. That is, one of the support member 112 and gasket 108 may be installed in the joint prior to the other. In selected embodiments, the support member 112 may be physically welded or attached to one of the cylindrical sections 102a, 102b prior to positioning the gasket 108 over the support member 112. In such embodiments, the support member 112 may also act as a guide to axially align the cylindrical sections 102a, 102b relative to one another when assembling the joint 104. In certain embodiments, the support member 112 may fit snugly within the inside diameter of the cylindrical sections 102a, 102b while still allowing axial movement (e.g., sliding) of the cylindrical sections 102a, 102b relative to the support member 112.

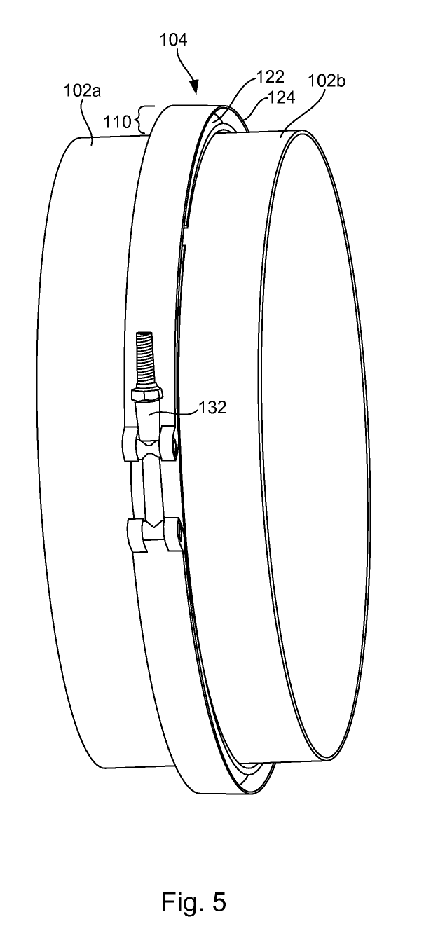

Referring to FIG. 5, once the gasket 108 and support member 112 are properly installed and positioned in the joint 104, the V-band clamp 110 may be tightened to urge the cylindrical sections 102a, 102b together and compress the gasket 108. As illustrated, a tension strap 124 of the V-band clamp 110 may include a bolt 132 or other fastener 132 to selectively increase or decrease tension in the strap 124. This tension compresses the V-band 122 which in turn urges the tapered flares 114a, 114b of the cylindrical sections 102a, 102b together.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a gasket having an annular shape and characterized by an outer circumference and an inner circumference, the gasket further having an inner thickness, proximate the inner circumference, tapering to an outer thickness, proximate the outer circumference, the inner thickness being substantially greater than the outer thickness.

2. The apparatus of claim 1, the gasket further having a first contact surface extending between the inner and outer circumference, and a second contact surface, opposite the first contact surface, extending between the inner and outer circumference.

3. The apparatus of claim 2, further comprising a first cylindrical section having a first flare along a circumference thereof, the first flare forming an obtuse angle relative to the first cylindrical section, the first flare contacting the first contact surface.

4. The apparatus of claim 3, further comprising a second cylindrical section having a second flare along a circumference thereof, the second flare forming an obtuse angle relative to the second cylindrical section, the second flare contacting the second contact surface.

5. The apparatus of claim 4, wherein the obtuse angle measures between about 95 degrees and 170 degrees.

6. The apparatus of claim 4, further comprising a support member to provide radial support to the gasket to keep the gasket positioned between the first and second flares.

7. The apparatus of claim 6, wherein the gasket and support member are integrated into a single component.

8. The apparatus of claim 4, further comprising a V-band clamp to contact and urge the first and second flares toward one another.

9. The apparatus of claim 1, wherein the gasket is characterized by at least one of a substantially triangular and a substantially trapezoidal cross-section.

10. An apparatus comprising:
an annular gasket characterized by an outer circumference and an inner circumference, the annular gasket having a cross-section the thickness of which tapers from the inner circumference to the outer circumference.

11. The apparatus of claim 10, the annular gasket further having a first contact surface extending between the inner and outer circumferences, and a second contact surface, opposite the first contact surface, extending between the inner and outer circumferences.

12. The apparatus of claim 11, further comprising a first cylindrical section having a first flare along a circumference thereof, the first flare forming an obtuse angle relative to the first cylindrical section, the first flare contacting the first contact surface.

13. The apparatus of claim 12, further comprising a second cylindrical section having a second flare along a circumference thereof, the second flare forming an obtuse angle relative to the second cylindrical section, the second flare contacting the second contact surface.

14. The apparatus of claim 13, wherein the obtuse angle measures between about 95 degrees and 170 degrees.

15. The apparatus of claim 13, further comprising a support member to provide radial support to the annular gasket to keep the annular gasket positioned between the first and second flares.

16. The apparatus of claim 15, wherein the annular gasket and support member are integrated into a single component.

17. The apparatus of claim 13, further comprising a V-band clamp to contact and urge the first and second flares toward one another.

18. The apparatus of claim 10, wherein the gasket is characterized by at least one of a substantially triangular and a substantially trapezoidal cross-section.

19. An assembly comprising:
an annular gasket characterized by an outer circumference and an inner circumference, the annular gasket having a cross-section the thickness of which tapers from the inner circumference to the outer circumference, the annular gasket further having a first contact surface extending between the inner and outer circumferences, and a second contact surface, opposite the first contact surface, extending between the inner and outer circumferences;
a first cylindrical section having a first flare along a circumference thereof, the first flare forming an obtuse angle relative to the first cylindrical section, the first flare contacting the first contact surface;
a second cylindrical section having a second flare along a circumference thereof, the second flare forming an obtuse angle relative to the second cylindrical section, the second flare contacting the second contact surface;
a support member to provide radial support to the annular gasket to keep the annular gasket positioned between the first and second flares; and
a V-band clamp to contact and urge the first and second flares toward one another.
